(19) United States
(12) Patent Application Publication
(10) Pub. No.: US 2009/0167870 A1
(43) Pub. Date: Jul. 2, 2009

(54) Method for Creating Custom Digital Images Utilizing Background Replacement Technology Over a Network

(76) Inventors: Serge Caleca, Escondido, CA (US); Tim Justice, Poway, CA (US); Steven Chua, San Diego, CA (US)

Correspondence Address: ERIC HANSCOM, 7395 PORTAGE WAY, CARLSBAD, CA, 92011, US

(21) Appl. No.: 11/968,640

(22) Filed: Jan. 2, 2008

(51) Int. Cl. H04N 5/225

(52) U.S. Cl. 348/207.1; 348/211.3; 348/E05.024

(57) ABSTRACT

A system and method for allowing a consumer to create a custom digital image with consumer selected backgrounds and foregrounds. Digital images are taken by a photographer and uploaded to a server. A consumer can log in to the server through a web browser and view the digital images. The background of the digital image can be removed. After selecting a digital image, the consumer can change the digital image's background and foreground, and change the position and size of the digital image relative to the background and foreground. Multiple photographers can use the same system to create a custom website that enables consumers to create custom digital images and order prints of the custom digital image or items that have the custom digital image printed on it. After the order is completed, the custom digital image is processed and printed, and mailed to the consumer or made available for pickup.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of photography, and more specifically toward a system and method for allowing a consumer to create a custom digital image with consumer selected backgrounds and foregrounds. Digital images are taken by a photographer and uploaded to a server. A consumer can log in to the server through a web browser and view the digital images. The background of the digital image can be removed. After selecting a digital image, the consumer can change the digital image's background and foreground, and change the position and size of the digital image relative to the background and foreground. Multiple photographers can use the same system to create a custom website that enables consumers to create custom digital images and order prints of the custom digital image or items that have the custom digital image printed on it. After the order is completed, the custom digital image is processed and printed, and mailed to the consumer or made available for pickup.

Photography, dating back to 1800's, has gone through much advancement throughout the years. Nicéphore Niépce is credited for taking the first permanent photograph in 1826, which required an eight hour exposure. In 1861, the first color photograph was taken. The first “easy-to-use” camera by Kodak was first marketed in 1888. Then came color photography and motion pictures. However, it wasn't until 1973 that photography entered into a digital medium, when the first large image forming CCD chip was released by Fairchild Semiconductor. Kodak is credited with creating the world's first megapixel sensor in 1986. These advancements have led to a large number of still photographs being taken by digital cameras, where these still photographs are known as digital images. Digital images can be stored in various forms of electronic memory, and are easily transferred from cameras to computers and from computers to computers, and are easily printed by a variety of printers onto a variety of mediums.

For generations now, people have been purchasing photographs to commemorate special events, achievements, milestones, or simply for the fun of it. Parents often purchase photographs of their children as they progress through the school system. Children's participation in sports is also often memorialized with photographs, both of the individual players and of the entire team. More recently, photographs are becoming popular at theme parks around the world, where patrons can purchase pictures of themselves in various locations undertaking various activities. For decades now, soldiers have had their picture taken, especially before being deployed. Currently, photography is a multi-billion dollar industry that is growing year by year.

As the market for photographs continues to grow, consumers expect a wider selection of high quality photographs at a lower cost, and advancements in picture taking technology give the user of a particular invention a decided competitive advantage over those practicing known techniques. It is currently well known in the art to allow consumers to view and purchase photographs over the internet. A photographer, after taking a digital image with a digital camera, makes the digital image available for consumers to view and purchase from the comfort of their own home. Consumers, on occasion, are able to download this digital image to their personal computer. Conversely, it is known in the art to allow consumers to upload their digital images to individuals or organizations that are capable of printing these digital images. This allows a consumer, who has taken his or her own digital image, to have it processed and printed by a professional.

There are many situations in photography where it may be beneficial to change the background of a photograph. For example, when a child has his or her school portrait taken, the background chosen for the child, whether by the parent, child, or school, may not complement the child. This situation can occur in almost any field of photography, however, as different backgrounds can complement the clothes, skin tone, eye color, hair color, or any other feature of the subject of the photograph. Further, different individuals viewing the photograph may differ on the appropriate background. Some may say that it is best to complement the clothes of the individual or individuals in the photograph, while others may say that it is best to complement the skin tones or eye color. The consumer, though, may want a different background than is provided at that moment, such as a different location or color theme. If the consumer does not like the resulting photograph, then the consumer will not purchase the photograph. Therefore, the background of the photograph is an extremely important choice; there is, however, no correct choice that will work for everyone. Different individuals will have differing opinions as to the best choice for the background of the photograph.

Various methods have been created to deal with this problem. Portrait studios will often take photographs of people against a variety of backgrounds such that the consumer may choose the best combination of people and background at a later date. This solution can work in some situations where the photographer has the various backgrounds that can easily be exchanged, but it can take a long period of time, which will lead to a more expensive product. The average school photography does not have the time or resources to take photographs of students against multiple backgrounds. Instead, the child, or more likely the parent, generally chooses the background before the picture is taken, and attempts to match his or her clothes to the background. Sports photography of young athletes occurs in a set location, usually without the option of different backgrounds. Photographs taken at theme parks or special events also usually do not have multiple different backgrounds; they are taken with whatever natural or staged background is present.

A more recent solution to this problem is through the use of chroma keying, which is a technique for blending two or more images together in which a color, or a small range of colors, is removed from one image revealing another image behind it. This technique is also known as color keying, greenscreening, and bluescreening. Basically, a photograph is taken of a subject, such as a person or persons, an object or objects, or any combination thereof, in front of a solid colored background. Later, the solid colored background is removed. This new photograph without a background is then placed over a different background. This process allows for the background of the photograph to be chosen after the photograph is taken. Further, it allows for the same photograph to have multiple different backgrounds. This means that different people can purchase the same photograph with different backgrounds to fit their needs.

The use of chroma keying is becoming more popular, but previously has not provided a complete solution to the problem. Chroma keying generally relies on expensive software, expensive hardware, or both to complete the process. This means that the average consumer is priced out of performing the chroma keying himself or herself. Therefore, the consumer must travel to the photographer and spend the time and money necessary to meet the photographer in the photographer's studio to create his or her custom photograph. The photographer must then spend more time with the consumer, thereby raising the cost to produce the custom photograph. Thus, the prior art has left a large gap in the products available to consumers who wish to have access to low-cost, easily customized photographs where the background of the picture can be chosen by the consumer at a time other than prior to the picture being taken. Prior to this invention, there has not been an inexpensive, efficient means for consumers to create a custom photograph using background replacement. This invention provides just such a solution.

It is also well known in the art to share photographs over the internet. Various internet web sites allow photographers to upload photographs, in digital format, to a server to make them available for purchase or download by consumers. Further, the prior art has disclosed uploading digital images with the background removed and allowing a consumer to choose his or her own background. The consumer can then order the resulting custom digital image. However, prior to this invention, there has been no system or method that discloses a system and method where multiple independent photographers or photographer studios can use a single system to enable consumers to create their own custom digital images, where the photographer can create settings for his or her consumers or a group of his or her consumers that change the options available to the consumers and the look and appearance of the web site the consumers use to create the own custom digital images. Additionally, there has been no prior art that teaches allowing a consumer to create a custom digital image over a network using a web browser where the custom digital image can then be placed in a special item, and then allow the consumer to order the special item, all through a web browser. Also, no prior art discloses a system and method where orders for prints or special items can be fulfilled by various different independent parties, where the parties are notified automatically when an order is placed by a consumer.

Thus there has existed a long-felt need for a system and method that can enable multiple photographers to take a photograph and make that photograph available to a consumer to create his or her own unique photograph over the internet. The consumer should then be able to purchase this photograph or special item containing this photograph from the same system and have it delivered to a location of his or her choosing. The photographer should also be able to customize the creating and ordering experience of the consumer. Further, multiple photographers should be able to use the same system to conserve resources. Also, the same system should be able to notify multiple parties when an order is placed.

The current invention provides just such a solution by having a system and method for allowing a consumer to create a custom digital image with consumer selected backgrounds and foregrounds. Digital images are taken by a photographer and uploaded to a server. A consumer can log in to the server through a web browser and view the digital images. The background of the digital image can be removed. After selecting a digital image, the consumer can change the digital image's background and foreground, and change the position and size of the digital image relative to the background and foreground. Multiple photographers can use the same system to create a custom website that enables consumers to create custom digital images and order prints of the custom digital image or items that have the custom digital image printed on it. After the order is completed, the custom digital image can be processed and printed, and mailed to the consumer or made available for pickup.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### SUMMARY OF THE INVENTION

The current invention is a system and method that allows consumers to have a photograph taken, preferably against a solid colored background, and then choose the background that the consumer wants at a later time over a network such as the internet through the use of a web browser, and then order that same photograph, or an item bearing that photograph, and have it sent to a location of his or her choosing. The photographer can customize the consumer's experience of creating and ordering the photograph by creating specific settings. The settings can affect options available to the consumer throughout the process as well as the visual appearance of the website that the consumer views through the web browser to create and order his or her custom photograph.

The system, in its simplest form, includes two main components: a photographer system and a server. The photographer system should include at least one local computer and a digital camera; however, multiple local computers and digital cameras can be included in each photographer system. The digital camera is used to take digital images of a subject against a solid colored background. The digital image is then transferred from the digital camera to the local computer. The background of the digital image is then removed such that only the subject remains. The digital image is then uploaded to the server. Before the consumer accesses the digital image on the server, the photographer can upload a variety of background digital images. The photographer can also log in to the server to create, edit, and save various settings associated with all the consumers associated with the photographer, or groups of consumers associated with the photographer. A consumer can then connect to the server over the network, and view the digital image. The consumer can choose from the variety of background digital images made available by the photographer and view the digital image with each one of these background digital images. The consumer may then select and purchase one or more prints of the digital image. The server will then contact the photographer that uploaded the digital image(s) or some other designated party, preferably via email, to notify the party that an order has been placed. Then, the digital image, with the custom background digital image selected by the consumer, is printed and shipped to the consumer or made available for pickup. The method follows the same steps outlined above using the same major components.

It is a principal object of the invention to provide a system and method to enable consumers to take advantage of background replacement of photographs while not in the presence of the photographer.

It is a further object of the invention to provide a system and method to enable consumers to take advantage of background replacement of photographs without requiring the consumer to purchase expensive software, hardware, or both.

It is another object of the invention to provide a system and method to increase the efficiency with which background replacement photographs can be taken, processed, and distributed to the consumer.

It is an additional object of the invention to provide a system and method for selling photographs to a consumer where the consumer can create multiple photographs using different backgrounds.

It is also an object of the invention to provide a system and method for selling photographs to a consumer where the consumer, photographer, or both can place additional images over their photograph.

It is a further object of the invention to provide a system and method for selling photographs to a consumer where the photograph is processed and printed by an individual or entity other than the original photographer.

It is another object of the invention to provide a system and method where multiple photographers can use the same system to sell their photos over the internet to consumers, thereby creating a more efficient and cost effective solution for selling custom background replacement photographs to consumers.

It is an additional object of the invention to provide a system and method where a multiple photographers can use the same server yet also be able to create a customized experience for their consumers.

It is also an object of the invention to provide a system and method that enables a consumer to create a custom photograph, and then view the custom photograph in a special item and order that special item with the custom photograph on it.

It is a final object of this invention to provide a system and method to allow consumers to replace the background of a photograph thereby creating a custom photograph and order said photograph over the internet.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a diagram of the major components of the system used to enable consumers to use background replacement technology to create their own custom photographs.

FIG. 2 is a detailed flow chart of the method used to enable consumers to create and purchase custom made photographs using background replacement technology.

FIG. 3 is a diagram of the typical process the photograph goes through, from the initial taking of the photograph of the consumer to the consumer receiving the custom digital image.

FIG. 4 is a diagram of the interconnectivity of the local computers, servers, and remote computers.

FIG. 5 is a diagram of the preferred workflow for creating the digital image of the custom photograph to display to the consumer.

FIG. 6 is a diagram showing the layers of digital images used to create a custom digital image or special item.

### DETAILED DESCRIPTION OF THE FIGURES

Many aspects of the invention can be better understood with reference to the drawings below. The components in the drawings are not necessarily drawn to scale. Instead, emphasis is placed upon clearly illustrating the components of the present invention. Moreover, like reference numerals designate corresponding parts through the several views in the drawings.

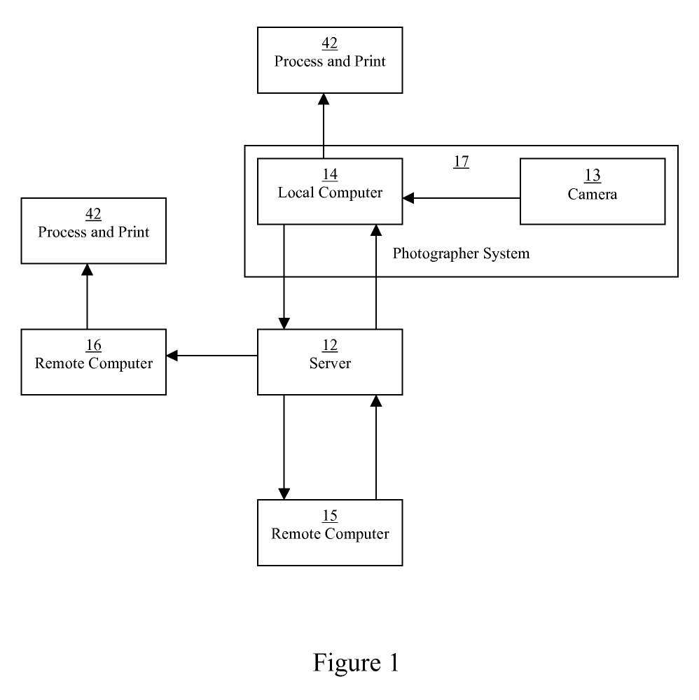

FIG. 1 is a diagram of the major components of the system used to enable consumers to use background replacement technology to create their own custom digital images. First, a digital camera 13 is used to take a digital image. In one embodiment of the current invention, the digital image of the subject is taken against a solid colored background. This allows for the background to be quickly and easily removed. In an alternative embodiment, the digital image of the subject is taken against any background. The subject could be of the consumer, people the consumer knows, or any other person or thing where it is desirable to take a photograph of the subject and replace the background. After the digital image has been taken on the digital camera 13, it is transferred to a local computer 14. At this stage of the process, the photographer prepares the digital image for upload to the server, which can include adjusting, tweaking, cropping, and converting the digital image to an appropriate file format. Also, the background of the digital image can be removed at this time. Alternatively, the background can be removed later in the process. The local computer 14 and the digital camera 13 constitute a photographer system 17, though the photographer system 17 could include multiple local computers, multiple digital cameras, or both. Once the digital image has been properly prepared on the local computer 13, it is uploaded to a server 12.

The server 12 is a computer that is used to store the digital images along with any other required settings, data files, background digital images, and foreground digital images. If the background of the digital image was not removed before the digital image was uploaded to the server 12, the background can be removed and the new version of the digital image without the background can be saved to the server 12. Alternatively, the background of the digital image can be removed each and every time the digital image is requested. A digital image is requested from the server 12 when a consumer logs in to the server 12 from a remote computer 15 through a web browser and the resulting web page includes a request for a digital image saved on the server 12. Preferably, the remote computer 15 connects to the server 12 over the internet; however, the remote computer 15 could connect to the server 12 over a local network, or the two computers can even be one and the same. When a consumer requests the digital image, the server 12 sends the digital image to the remote computer 15 with a new background, which in most circumstances is a background that the consumer has chosen. The consumer can also adjust the size of the digital image compared to the new background, as well as the relative position. When the consumer is happy with the created custom digital image, the custom digital image, or the data necessary to create the custom digital image, is stored on the server 12. The consumer is now free to create additional custom digital images, or finish the process by placing an order.

After the consumer places an order on the server 12 from the remote computer 15, the photographer is notified that an order has been placed. The custom digital photograph, or data necessary to create the custom digital photograph, can be sent to the local computer 14 of the photographer, or accessed from the server 12 via the local computer 14 or any other computer able to connect to the server 12. There may be occasions, however, where the photographer will not fulfill the order, but rather a third party vendor. If this is the case, a third party vendor will be notified of the order. The custom digital image, or data necessary to create the custom digital image, can be sent to the local computer 16 of the third party vendor, or accessed from the server 12 by the third party vendor via the local computer 16 or any other computer able to connect to the server 12. The third party vendor could be another photographer who is more ready, able, or willing to fulfill the order. Whether the photographer or the third party vendor receives the order, either then processes and fulfills the order 42 whereby the custom digital image or item containing the custom digital image that the consumer purchased is shipped or otherwise made available to the consumer.

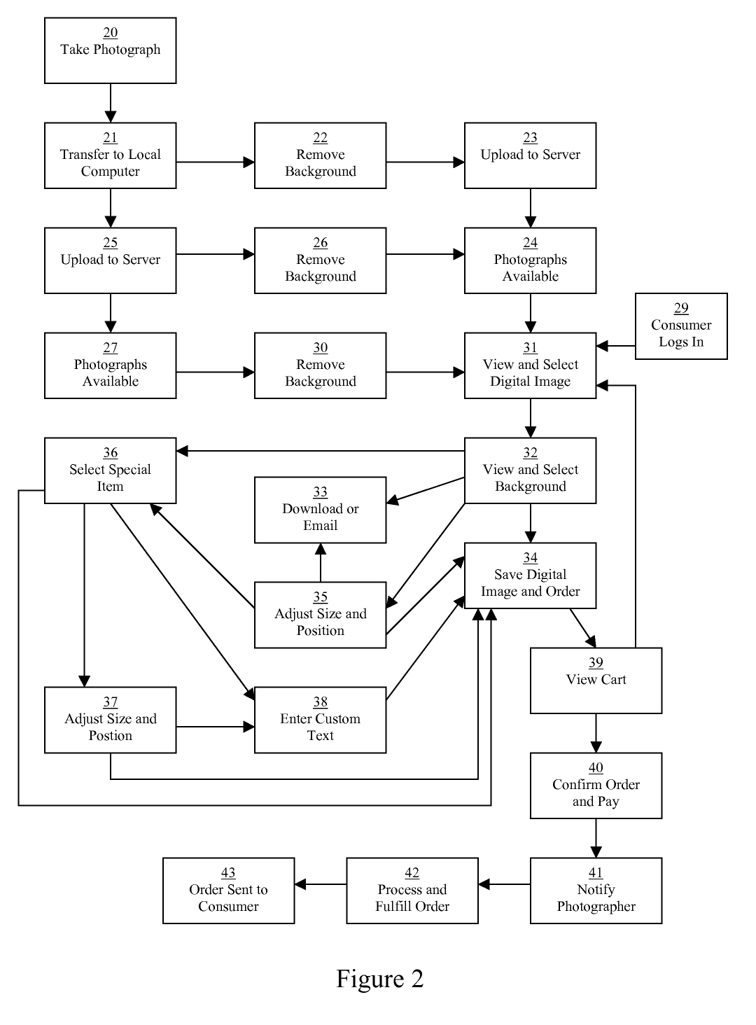

FIG. 2 is a detailed flow chart of the method used to enable consumers to create and purchase custom made photographs using background replacement technology. Taking a photograph 20 with a digital camera starts the process. Different cameras are available to take the photograph, but the camera is preferably a digital camera that can produce a digital image with a high enough resolution to create a quality photograph when printed. The digital image that is taken by the camera can also be saved in a variety of formats. Some formats include RAW, TIFF, and most common, JPEG. When the photograph is taken, the digital image is usually stored on internal or removable memory located inside of the camera. Once one or more photographs have been taken, the resulting digital images are transferred to a local computer 21 where they are saved in the computer's internal memory. It is possible, though, to connect the digital camera to the local computer such that right after a photograph is taken 20, the digital image is immediately transferred to the local computer 21 without being saved in the camera.

Once the photograph is stored as a digital image on the local computer, any necessary tweaking, adjustment, and processing is performed to prepare the digital image to be uploaded to a server. This step can include removing the background of the digital image. The key to removing a background from a digital image quickly, efficiently, and correctly is that the photograph was taken against a solid colored background. Blue or green are colors commonly used for this process as they are considered to be the furthest away from skin tones. Green is preferably used over blue in this process because digital cameras tend to retain more detail in the green channel than with blue because of green's higher luminance value, therefore requiring less light for the background and making it easier to work with. While green and blue may be preferable, any solid colored background may be used in the process to fit the needs of the particular photograph to be taken.

The prior art contains many different systems and methods for removing backgrounds from photographs. One particular system removes a background by removing a color or similar colors from a photograph. Digital images are generally broken up into a number of small picture elements, known as pixels. Each pixel has a specified color. It is by combining these pixels together, each with their own color, that the digital image is created. A background is removed by removing a specific color, or colors similar to it, from the digital image. Each pixel's color is compared to the specific color designated as the background color, such as the color of a green screen or blue screen, and if it is the same or relatively close, the pixel is a part of the background and should be removed. This is why having a solid colored background has such great importance. The background of the digital image should be created such that a narrow range of colors is produced as the background. Solid colored backdrops are often used to create the solid colored background. It is important, however, to have even lighting across the backdrop. Shadows or uneven lighting can cause the color of the background to change far enough from the specified background color such that it is not identified as being a part of the background and is not removed.

While it may be preferable to take the picture against a solid colored background, there are alternative means for removing the background of a photograph without using a solid colored background. These can be done by manually selecting which part of the image should be removed, or alternatively, which part of the image should be kept. Software such as Mask Pro by on One Software or KnockOut by Corel can be used to aid the user in removing the non-solid colored background of a digital image. Technology may also be available to the user of the invention to remove a non-solid colored background automatically without the use of a solid colored background. Various means for removing a background of a digital image can be used so long as the background is removed from the digital image while leaving the subject.

The pixel, however, cannot be removed, as this would delete a part of the image. Instead it is preferable to change the pixel such that it is transparent. This is often done with an alpha channel. An alpha channel defines the transparency of the pixels of the digital image, whereby each pixel can have a specified transparency such that the pixel can be opaque, transparent, or somewhere in between. If the file format of the digital image supports alpha channels, then the image can be saved with the background removed by setting those corresponding pixels to transparent. File formats that that include an alpha channel are TIFF, PNG, and Photoshop® files. PNG files are preferable as it is lossless format that is easily manipulated in many programming languages, including web-programming languages such as PHP. The draw back of the file formats that include an alpha channel is that they tend to be large in size and, when storing many thousands of digital images, can quickly use up valuable hard disk space. Some file formats, however, do not support alpha channels, such as the JPEG format. Therefore, the photograph without the background cannot be saved into a JPEG format. If it is desirable to maintain the photograph in a format that does not support alpha channels, for example, in efforts to conserve hard drive space, then a mask can be created. A mask is similar to an alpha channel; it defines the transparency of the pixels of the image, but is saved as a separate digital image. The mask can then be used later to compose a digital image without the background more quickly and efficiently. The transparency of the pixels need not be determined again.

Following the previous steps creates a photograph saved as a digital image without the background or as separate digital images where one is the photograph and the other defines the background to be removed. In other words, the background is removed 22. In one embodiment of the invention, the photograph is taken 20, the resulting digital imager is transferred to a local computer 21, and the background is removed 22. Once the background has been removed 22, the digital image is uploaded to the server 23. The digital image of the photograph uploaded to the server should, generally, be reduced in size. This reduces the hard disk space used by each digital image on the server. A preferable size for the digital image is no larger than 640 by 640 pixels, as this size is large enough to view most of the details of the digital image on a computer screen, but small enough to save considerable amounts of disk space on the server. The uploaded digital image is then made available 24 to consumers.

In an alternative embodiment of the invention, the digital image of the photograph is uploaded to the server 25 before the background is removed. In this iteration, the digital image of the photograph uploaded to the server should, generally, be reduced in size. After the digital image has been uploaded to the server 25, the background is removed 26. The same process used to remove the background before it is uploaded can be used to remove the background after it is uploaded. This process can be automated, whereby the server has been preprogrammed with or detects the background color and removes the background, or the process can be manual, whereby the photographer connects to the server and directs the server to perform the removal of the background. After the background is removed 26, the digital image of the photograph without the background is saved to the server, and the digital image is then made available 24 to consumers.

In another embodiment of the invention, the digital image of the photograph is uploaded to the server 25 and then the digital image is made available 27 to consumers without first removing the background and saving the resulting digital image. In this iteration, the digital image of the photograph uploaded to the server should, generally, be reduced in size. After the digital image has been uploaded to the server 25, it is made available 27 to consumers. The system will then remove the background 30 each and every time that consumer requests the digital image. This is an automated process whereby the server has been preprogrammed with or detects the background color and removes the background. This allows for smaller file sizes of the digital images of the photograph to be stored on the server, since any alpha channel or mask data required is created each and every time the photograph is accessed. This can be beneficial for systems with a large volume of photos, limited hard disk space, or both. However, because the server must process digital image and remove the background each time the image is requested, this can be taxing on the processor and random access memory (“RAM”) of the server, and may cause slow performance.

Once the digital image is available 27, consumers can log in 29 to the server over the internet using a web browser and select the digital image 31. Depending on the requirements of the photographer, consumers, and other factors, the consumer may log in 29 by entering a log in ID, entering a username and a password, or simply by connecting to the server. Requiring the consumer to enter a log in ID or a username and password is preferable. It restricts access to the digital images by only allowing those consumers with the correct log in ID or username and password combination to view, create, and order the digital images. Also, it is a means for the consumer to quickly locate the digital images that the consumer wishes to view without needlessly searching through a possible large number of digital images. Many digital images can be associated with a single log in ID or username and password combination. This often occurs when the photographer takes multiple digital images of the same individual or group of individuals, and wishes to offer them a choice of which digital image to choose.

In a preferred embodiment of the invention, the consumer is given a web address and a username and password combination after the photographer has taken one or more digital images. The consumer types in the web address in the web browser of the consumer's computer. This connects the consumer to the server. Further, the web address can also be used to identify which photographer the consumer is associated with. For example, the web address given to the consumer could be “http://photographer.domainname.com.” The “domainname.com” portion of the web address could connect the consumer to the server, while the “photographer” portion of the web address could be used to identify which photographer is associated with the consumer. The consumer then enters the username and password combination, and the server displays to the consumer, through the web browser, only those digital images associated with the consumer.

The web address and username and password combination can also be used by the system to enable the photographer to create a customized experience for the consumers. The photographer can log in to the server and create, edit, and save settings for consumers that are associated with the photographer. The settings can be for options available to the consumer, such as what prints, special items, and shipping options the user can choose as well as what discounts and tax may apply to the order. The photographer can also group consumers together, such that different groups of consumers that are associated with the photographer can have different settings. Various means well known in the art can be used to create and associated the consumer, the username and password combination, the group the consumer is in, and the digital images associated with the consumer, such as by using a unique file structure, data files, or a database. For example, the photographer could have a folder, known as a photographer folder, located on the server. Inside of the photographer folder, there can be another folder known as a username folder, which corresponds to a username entered by a consumer. Inside of the username folder there can be a password folder, which corresponds to a password entered by a consumer. Therefore, when the consumer enters the web address and then enters the username and password combination, the server can locate appropriate digital images and settings that are located inside of the photographer folder, found from the web address, the username folder, found from the username, and the password folder, found from the password. The file structure method could also be used in conjunction with data stored in files as well as in a database, which can be tailored to the specific embodiment of the current invention.

After the consumer logs in 29 to the server, can view and select digital image 31, where the digital image is displayed without the digital image's original background, but with a default background. This default background can be a setting specified by the photographer or by the system itself if nothing is specified by the photographer. If the consumer has more than one digital image associated with the username and password, then those digital images are displayed to the consumer as well, allowing the consumer to view multiple digital images at the same time. After the consumer views and selects a digital image 31, the consumer is given a choice of backgrounds to use with the digital image.

There are various ways to aid the consumer in selecting a new background. Background digital images can be grouped into categories, allowing the consumer to select a category and only view the background digital images in that category. One option for enabling a consumer to choose a background is to display multiple background digital images to the consumer, and the consumer chooses his or her favorite. Alternatively, the consumer's chosen digital image can be placed over each background digital image. This allows the consumer to quickly see how his or her chosen digital image will look against a variety of backgrounds at the same time. Preferably the consumer can select between the two options to meet his or her preference. The background digital image may be saved in a file format that uses relatively little hard disk space, such as the JPEG format, since no alpha channel is required.

Optionally, the system and method should allow for foreground digital images to be used as well. Foreground digital images are placed over the digital image. For example, the photographer may desire that watermark be placed over all of the images displayed to the user. The watermark could include copyright or other ownership information, to deter illegal copying of the image. Alternatively, the photographer may be willing to distribute the images for free, but with an advertisement or message from a sponsor. It may also be beneficial to allow the consumer to select a foreground digital image, similar to selecting a background digital image. The foreground digital image is preferably in a file format that includes an alpha channel such that a portion of the image is transparent, which will show the custom digital image, background digital image, or both.

After the consumer has viewed and selected a background 32 for the photograph, thereby creating a custom digital image, the consumer has a variety of choices. One option is for the consumer to download or email 33 the custom digital image. Downloading the custom digital image allows the consumer to have a copy of the custom photographer on his or her own computer in digital format. Emailing the custom digital allows the consumer to send a copy of the custom photograph in digital format to one or more email addresses of his or her choice. There is almost no cost to the photographer for this service, as everything is automated.

If the consumer wishes to order the custom digital image, the server will save the custom digital image and order 34 after the consumer has ordered. It is also possible to save the custom digital image and the order separately and at different times, though preferably the custom digital image is saved before or at the same time the custom digital image is ordered. Preferably, the custom digital image is not stored on the server; rather, just the data necessary to create the custom digital image is stored. This reduces the amount of hard disk space used in the process. It is also preferable that this data, along with the order data, be stored in a database, as this allows for quick and easy access to the required information and also allows for easily generating statistics and reports of the data stored on the server. It is nonetheless possible, however to save the actual custom digital image to the server in a variety of formats, as well as store the data from the custom digital image and the order in computer files, such as XML files, CSV files, or any other structure where data can be stored for access at a later time. When ordering the custom digital images, the consumer can be given a variety of choices, from different sizes, such as 8×10, 5×7, 4×6, and 3×5, to the format, including glossy prints, matte prints, or the like, to the quantity desired. These can be standard choices available to all consumers from all photographers, or custom choices created by the photographer for all of the photographer's consumers or a group of the photographer's consumers.

After the consumer has viewed and selected a background digital image 32 for the digital image, the consumer may have the option of adjusting the size and position 35 of the photograph relative to the background. This is an additional level of customization that allows the consumer to create his or her desired custom digital image. The consumer should be allowed to shift the digital image left, right, up, or down relative to the selected background digital image. The consumer should also be allowed to make the digital image larger or smaller relative to the selected background digital image. It may also be beneficial to allow the consumer to rotate the digital image relative to the background digital image. Once the consumer is finished adjusting the size and position 35 of the digital image, the consumer is allowed to download or email 33 the custom photograph, save the custom digital image and order it 34, or select a special item 36.

The photographer can allow the consumer to select a special item 36 directly after the consumer has viewed and selected a background digital image 32 or after the consumer has finished adjusting the size and position 35 of the digital image. Special items can be used to aid the consumer in ordering items such as holiday cards, layouts, magazine covers, frames, mugs, or any other item where viewing the custom photograph on or inside of another item or graphic is desirable. For example, a consumer may order holiday cards by first creating his or her custom digital image, and then selecting a particular holiday card template. The custom digital image can then be placed inside of the holiday card to show the consumer what the finished holiday card product will look like. This is achieved by using an additional background digital image and an optional additional foreground digital image. The custom digital image is placed over a portion, preferably not the entire portion, of the additional background digital image. The additional background digital image may be uploaded to the server and saved in a file format that uses relatively little hard disk space, such as the JPEG format, since no alpha channel is required. Then, if needed, an additional foreground digital image is placed over the additional background digital image and custom digital image. The additional foreground digital image is preferably in a file format that includes an alpha channel such that a portion of the image is transparent, which will show the custom digital image, additional background digital image, or both. Another example is where a consumer wishes to order a mug with the custom digital image. The custom photograph is placed over an additional background digital image, where the additional background digital image is a digital image of a mug. This allows the consumer to view what a mug would look like if it had his or her custom digital image printed on it. Once the consumer has selected a special item, the consumer is allowed to adjust the size and position 37 of the custom digital image relative to the special item, enter custom text to the special item 38, or save the custom digital image in the special item and order it 34.

Adjusting the size and position 37 of the custom digital image relative to the special item functions similarly to adjusting the size and position 35 of the digital image relative to the background digital image. In this option, however, the custom digital image is sized and positioned relative to the additional background digital image and optional additional foreground digital image of the special item. The special item with the custom digital image can then either be saved and ordered 34 or, if required, the consumer can enter custom text 38.

If the circumstances dictate, the consumer should be allowed to enter custom text 38 that will be included with the special item. This often occurs when the consumer is ordering items such as holiday cards, magazine covers, or other items where it is desirable to have personalized text. If this is the case, then the consumer can enter custom text 38, where the custom text becomes a part of the special item displayed to the consumer. The consumer or the photographer can select the font that is used to create the text, and the text can be shown over the additional background digital image, additional foreground digital image, over the custom digital image, or a combination thereof. The consumer should also be able to view the custom text and then edit the text if desired. Once the consumer has entered the custom text 38 and is pleased with the result, the special item with the custom digital image is saved and the consumer is allowed to order the item 34.

Once one or more custom digital images or special items have been ordered, the consumer can view the shopping cart 39. The shopping cart allows the consumer to view items that consumer has previously selected to order. It is similar to an actual shopping cart in grocery store; the consumer can view the items he or she wishes to order before actually purchasing the items. The shopping cart should display all of the custom digital images or special items ordered along with relevant shipping, discounts, or other information related to the order. From here, the consumer should be allowed to view and select digital images 31 again to create additional custom digital images or to confirm the order and pay 40. The consumer can pay for the custom digital images and special items ordered over the internet through the same web browser used to create the custom digital image and order it. Various means of payment are possible, including credit card and electronic check. After the order has been confirmed and payment made, the server will notify the photographer 41. After the photographer is notified the photographer will process and fulfill the order 42. Once the order has been processed and fulfilled 42, the order is sent to the consumer 43, made available for the consumer to pick up, or sent to another party of the consumer's choosing. Alternatively, after the order has been confirmed and payment made, the server will notify any party or number of parties, such as a third party vendor, that have been specified to receive notifications of orders. This can be helpful if third party vendors are used to process and fulfill orders of certain kinds, such as special items, where the photographer is unable or unwilling to do so.

This completes the process for enabling a consumer to have a photograph taken, removing the background, creating a custom digital image with a background of the consumer's choosing, ordering the custom digital image or an item using the custom digital image, paying for the order, notifying the appropriate party to fulfill the order, and then sending it or making it available to the consumer.

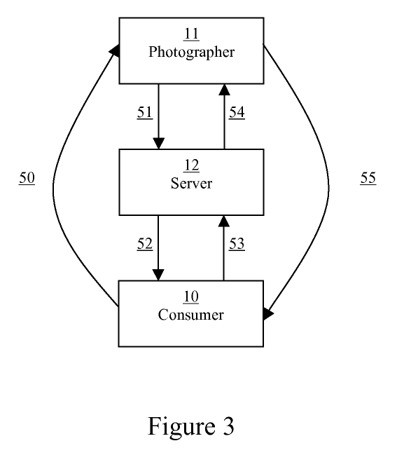

FIG. 3 is a diagram of the typical process the photograph goes through, from the initial taking of the photograph of the consumer to the consumer receiving the custom digital image. First a photograph is taken 50 of the consumer 10 by the photographer 11. The photographer prepares the photograph and then sends the photograph 51, as a digital image, to the server 12. The consumer 10 can then access the digital image 52 from the server 12. The consumer 10 then creates a custom digital image 53 on the server 12. After the consumer 10 places an order on the server 12, a notification is sent 54 to the photographer 11, preferably as an email. The photographer 11 then processes and fulfills the order and then sends the order 55 to the consumer 10, thereby completing the process.

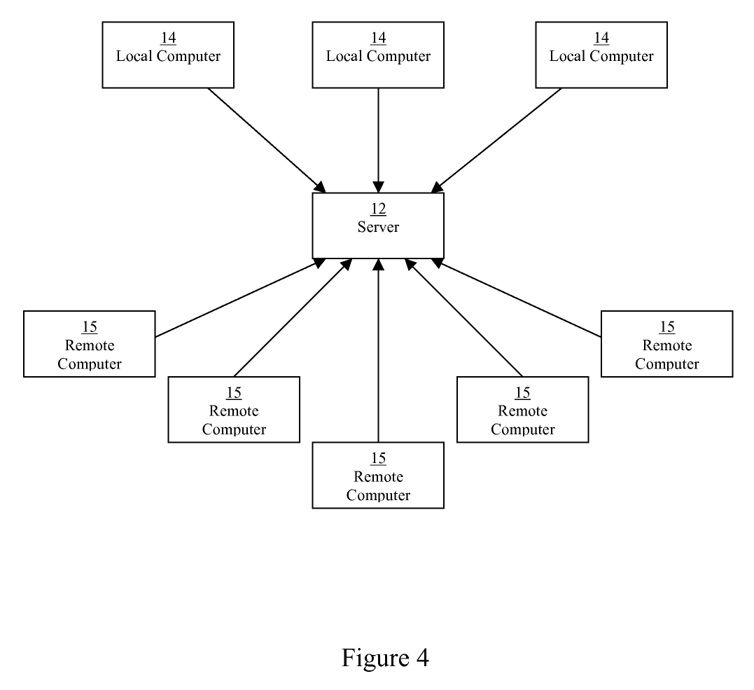

FIG. 4 is a diagram of the interconnectivity of the local computers, servers, and remote computers. A single photographer can use multiple local computers 14, and these local computers 14 can each connect to a server 12. Also, multiple different photographers using multiple different local computers 14 can also connect to the same server 12. Multiple different remote computers 15 are also intended to access the same server 12 that the local computers 14 connect to. Further, multiple servers 12 can be linked together as known in the art to serve the same function as a single server, but with increased capacity to handle the connections from both the local computers 14 and the remote computers 15.

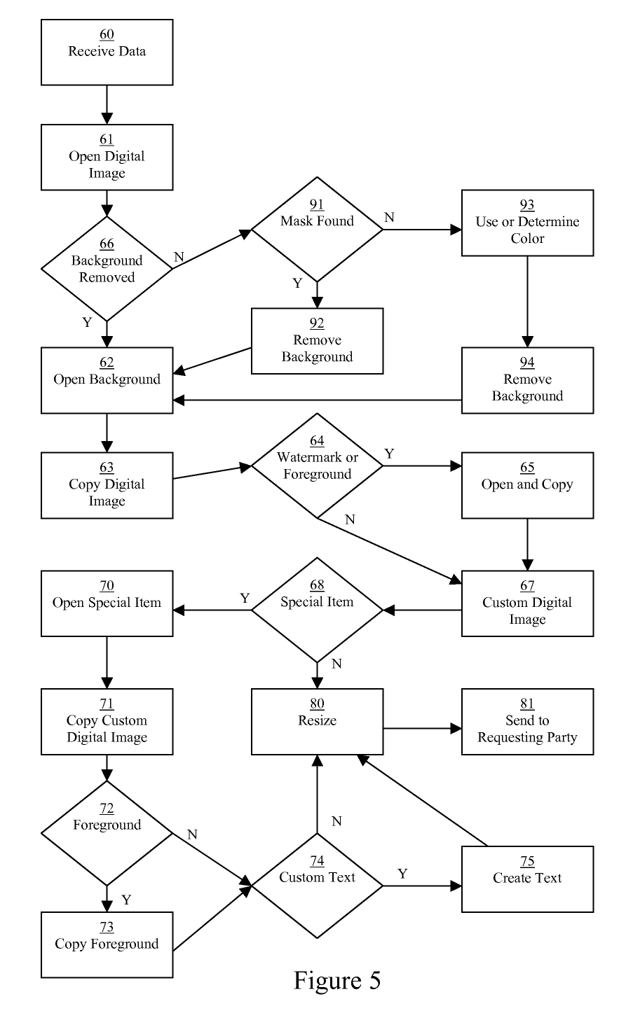

FIG. 5 is a diagram of the preferred workflow for creating the digital image of the custom photograph to display to the consumer. The following description can serve as a roadmap for designing a computer script to create a requested custom digital image and any special item. To start, a request is received asking for a digital image to be sent. Data is received 60 from the requesting party that is used to create the custom digital image. Next, using the received data, the digital image of the photograph is opened 61. The digital image is preferably in a PNG format with the background removed (made transparent). Next, it needs to be determined whether the background of the digital image has been removed 66. If it has, such as by using the preferable PNG format with the background removed mentioned above, then the process continues. If not, then the script should determine whether there is a mask digital image that contains data showing the transparency of each pixel of the digital image 91. If there is, then the mask digital image should be opened and used to remove the background of the digital image 92. If, however, there is no mask digital image, then other means should be used to remove the background 93. A pre-set color could be used to remove that color and similar colors from the digital image in an effort to remove the background 94. Alternatively, the appropriate color to remove could be determined by sampling the entire image, the corners of the image, or some other method known in the art to determine the correct background color, and then remove this and similar colors from the digital image to remove the background 94. Once the digital image has been opened and the background digital image has been removed, the background digital image specified by the received data is opened 62. Then the digital image is copied onto the background digital image 63 creating a custom digital image. The background digital image is preferably in a JPEG format, as no transparency is required for the background image with the JPEG format. The background digital image does not require any transparency because there is no other image to be displayed behind the background digital image. In other words, nothing is intended to be visible behind the background digital image. The received data may include positioning, sizing, and rotational data that is used to position the digital image on the background digital image. Next, if there is a watermark or foreground digital image 64, this watermark or foreground digital image is copied onto the custom digital image 65. The watermark or overlay digital image is preferably in a PNG format, as an alpha channel is required to allow the composed image to show through. This process results in the creation of a custom digital image 67.

Whether there is a special item 68 determines the next step. If there is no special item specified in the received data, then the digital image is resized 80 and the resulting image is sent to the requesting party 81. The image is resized 80 as requested in the received data. This allows for smaller sized images, such as thumbnails, to be sent when needed instead of larger sized images. This reduces amount of data required to be transferred from the server to the remote computer, such as when multiple custom images are requested to be displayed on a single web page by a consumer.

If, on the other hand, there is a special item specified in the received data, the special item is opened 70, which includes opening an additional background digital image as well as a special item data file and an additional foreground digital image, if available. Then the custom digital image is copied onto the additional background digital image 63 creating a special item digital image. The additional background digital image is preferably in a JPEG format, as no transparency is required for the additional background digital image. The special item data file may also include positing, sizing, and rotational data used to initially position the custom digital image on the additional background digital image. The received data may include positioning, sizing, and rotational data that is used to further position, size, and rotate the custom digital image on the additional background digital image. If there is an additional foreground digital image 72 available, the additional foreground digital image is copied 73 onto the special item digital image. If there is no additional foreground digital image available, or after the additional foreground digital image has been copied onto the special item digital image, the next step depends on whether there is custom text in the received data 74. If there is custom text in the received data, then the custom text is copied onto the special item digital image. If there is no custom text in the received data, or once the custom text has been copied onto the special item digital image, the special item digital image is resized 80 and the resulting image is sent to the requesting party 81.

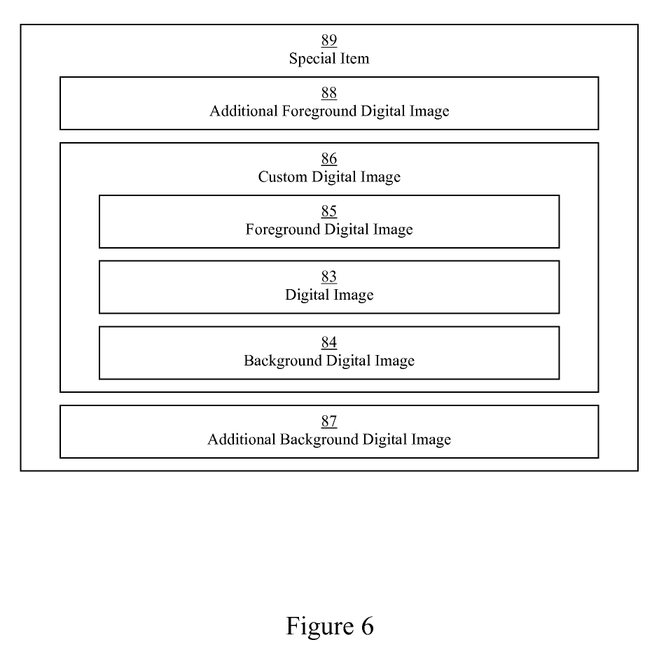

FIG. 6 is a diagram showing the layers of digital images used to create a custom digital image or special item. The digital image 83 is first copied onto a background digital image 84. A foreground digital image 85 can then be copied on top of the digital image 83. The combination of these three elements creates a custom digital image 86. The digital image 83 can be sized, positioned, and rotated relative to the background digital image 84 and the foreground digital image 85. The custom digital image 86 can then be copied over an additional background digital image 87. An additional foreground digital image 88 can then be copied on top of the custom digital image 86. All of these layers can be combined to create a special item digital image.

While the current system and method is preferably used over the internet, it is nonetheless possible to use the current invention over a local network without departing from the scope of the claimed invention. Further, while the preferred embodiments of the current invention often refer to a single photograph or digital image throughout much of the process, it should be understood that multiple photographs or digital images can be used, created, sent, or the like, simultaneously or consecutively, in the same fashion without departing from the scope of the claimed invention. Also, a local computer, a server, and a remote computer could, in some embodiments be one and the same computer that contains all the functionality specified above. If this is the case, then all communication is done within the computer, and the computer requires no external network access. Reference is made to special items, which are customized items that the photographer wishes to sell to consumers, where these customized items can include more than a single image, background, or foreground. References made to a single photographer are meant to include photographer studios or organizations of photographers that operate as a single entity.

There are several advantages of the current system and method over the prior art. The current invention provides a system and method where multiple independent photographers can upload digital images to a single server, where consumers can connect to the server and then create and order custom digital images and special items. Each photographer can create and edit settings to customize what options consumers have available and the visual appearance of the website used while creating and purchasing their custom digital images. Further, the photographer can break his or her consumers into groups and create separate and different settings for each of these groups. Additionally, there has been no prior art that teaches allowing a consumer to create a custom digital image over a network using a web browser where the custom digital image can then be placed in a special item, and then allow the consumer to order the special item, all through a web browser. Also, no prior art discloses a system and method where various different independent parties can fulfill orders for prints or special items, where the parties are notified automatically when an order is placed by a consumer.

What I claim is:

1. A method for enabling consumers to create their own custom digital images using background replacement technology comprising the steps of:
(a) taking a photograph of a subject in front of a background, where the photograph is in the form of a digital image,
(b) reducing the size of the digital image,
(c) uploading the digital image to a server,
(d) enabling a consumer to view, select, and create a customized digital image over a network through the use of a web browser, where the consumer creates a customized digital image by at least selecting the digital image and a background digital image for the customized digital image, where the digital image is placed over the background digital image to create the customized digital image,
(e) saving data necessary to create the customized digital image on the server,
(f) allowing the consumer to purchase a print of the customized digital image,
(g) sending the data necessary to create the customized digital image to a party capable of printing the customized digital image,
(h) locating and transferring the digital image from step (a) to the party capable of printing the customized digital image, if necessary,
(i) using the data necessary to create the customized digital image to create the customized digital image,
(j) printing the digital image, and
(k) sending the print to the consumer or otherwise making it available for the consumer to obtain,
where the background of the original digital image from step (a) is removed after step (a) and before the consumer views the digital image over the internet thereby showing any background digital image that is present behind the digital image,
where the resulting customized digital image is not saved on the server, but the data necessary to create the custom digital image is saved on the server,
where, in step (h), the digital image may already be in the possession of the party capable of printing the customized digital image thereby removing the necessity for locating and transferring the digital image,
where the data necessary to create the customized digital image comprises a digital image file name and a background file name,
where one or more digital background images have been uploaded to the server prior to step (d),
where the consumer is provided information from the photographer, where the information includes at least a web address and a means to associate one or more digital images to the consumer, where the web address is used to connect to the server over the network, where the web address, means to associate one or more digital images to the consumer, or both are used to identify which photographer is associated with the consumer,
where a photographer can log onto the server prior to step (d) and create settings for all of the consumers that are associated with the photographer, groups of consumers that are associated with the photographer, or both thereby enabling the photographer to create a unique experience for consumers to create custom digital images and then order those images over a network.

2. The method of claim 1, where the network is the internet.

3. The method of claim 1, where the background is a solid colored background, and where the solid colored background is blue or green.

4. The method of claim 1, where in step (b) the size of the digital image is reduced to a size no larger than 640 pixels of height or width.

5. The method of claim 1, where in step (c) the digital image is uploaded to the server using file transfer protocol.

6. The method of claim 1, where in step (d) the consumer further creates the customized digital image by adjusting the size, position, or both of the digital image relative to the background digital image.

7. The method of claim 1, where in step (d) the consumer further creates the customized digital image by selecting a foreground digital image, where the foreground digital image is placed over the customized digital image thereby creating the customized digital image, and where one or more foreground digital images have been uploaded to the server prior to step (d).

8. The method of claim 1, where the photographer creates a setting on the server such that a foreground digital image is placed over every custom digital image created by a consumer.

9. A method for enabling consumers to create their own custom digital images using background replacement technology and then order an item containing the custom digital image comprising the steps of:
(a) taking a photograph of a subject in front of a background, where the photograph is in the form of a digital image,
(b) reducing the size of the digital image,
(c) uploading the digital image to a server,
(d) enabling a consumer to view, select, and create a customized digital image over a network through the use of a web browser, where the consumer creates a customized digital image by at least selecting the digital image and a background digital image for the customized digital image, where the digital image is placed over the background digital image to create the customized digital image,
(e) saving data necessary to create the customized digital image on the server,
(f) enabling the consumer to view, select, and create a customized item that includes the customized digital image, where the consumer creates the customized item by at least selecting an item and the customized digital image,
(g) saving the data necessary to create the customized item on the server,
(h) allowing the consumer to purchase the customized item,
(i) sending the data necessary to create the customized item, which includes the data necessary to create the customized digital image, to a party capable of producing the customized item,
(j) locating and transferring the digital image from step (a) to the party capable of producing the customized item, if necessary,
(k) using the data necessary to create the customized item to create the customized item,
(l) creating the customized item, and
(m) sending the customized item to the consumer or otherwise making it available for the consumer to obtain,
where the background of the original digital image from step (a) is removed after step (a) and before the consumer views the digital image over the internet,
where the resulting customized digital image is not saved on the server,
where, in step ( ), the digital image may already be in the possession of the party capable of producing the customized item thereby removing the necessity for locating and transferring the digital image,
where the data necessary to create the customized item comprises a digital image file name, a background file name, and an item name,
where one or more digital background images have been uploaded to the server prior to step (d),
where the consumer is provided information from the photographer, where the information includes at least a web address and a means to associate one or more digital images to the consumer, where the web address is used to connect to the server over the network, where the web address, means to associate one or more digital images to the consumer, or both are used to identify which photographer is associated with the consumer,
where a photographer can log onto the server prior to step (d) and create settings for all of the consumers that are associated with the photographer, or groups of consumers that are associated with the photographer, thereby enabling the photographer to create a unique experience for consumers to create customized items, which include a custom digital image, and then order those items over a network.

10. The method of claim 9, where the background is a solid colored background, and where the solid colored background is blue or green.

11. The method of claim 9, where in step (b) the size of the digital image is reduced to a size no larger than 640 pixels of height or width.

12. The method of claim 9, where in step (c) the digital image is uploaded to the server using file transfer protocol.

13. The method of claim 9, where in step (d) the consumer further creates the customized digital image by adjusting the size, position, or both of the digital image relative to the background digital image.

14. The method of claim 9, where in step (f) the consumer further creates the customized item by adjusting the size, position, or both of the customized digital image relative to the item.

15. The method of claim 9, where in step (f) the consumer further creates the customized item by adding text to the item.

16. The method of claim 9, where in step (d) the consumer further creates the customized digital image by selecting a foreground digital image, where the foreground digital image is placed over the customized digital image thereby creating the customized digital image, and where one or more foreground digital have been uploaded to the server prior to step (d).

17. The method of claim 9, where the photographer creates a setting on the server such that a foreground digital image is placed over every custom digital image created by a consumer.

18. A system for enabling consumers to create custom digital images using background replacement whereby the consumer can create a custom digital images over the internet using a web browser comprising
two or more photographer systems and a server,
where a photographer system comprises a camera and a local computer, where the camera is a digital camera, where the local computer is a computer, where the digital camera is capable of connecting to and communicating with the local computer, where the server is a computer, and where the local computer is capable of connecting to and communicating with the server,
where the camera can take a digital image of a subject against a solid colored background, where the digital image can be broken up into individual pieces of the photograph called pixels, where digital images taken by the camera can be transferred to the local computer, where the local computer can remove the background from a digital image and save the image in a file format that includes an alpha channel, where the alpha channel defines the transparency of each pixel, and where the digital images can be associated with a photographer and one or more consumers,
where each of the two or more photographer systems can upload digital images to the server, where the digital images are stored on the server and associated with the photographer that uploaded the digital images as well as the one or more consumers the digital image was associated with on the local computer, where the photographer can upload background digital images,
where two or more consumers can log in to the server over the internet using a web browser, where each consumer is shown the digital images associated with that consumer, where the digital images are viewed through a website, where the website can be customized by the photographer, where the consumer can select a digital image and a background digital image thereby creating a custom digital image that places the digital image over the background digital image, where the custom digital image is displayed to the consumer, where the consumer can purchase the custom digital image over the internet,
where the photographer can customize the website by logging in to the server over the internet using a web browser, and where the photographer can create, edit, and save one or more settings that change options available to the consumer or the visual appearance of the website displayed to the consumer,
where the consumer can purchase one or more custom digital images while logged into the server, and
where, after the consumer has purchased the one or more custom digital images over the internet, the photographer, a third party vendor, or both are notified of the purchase.

19. The system of claim 18, where the consumer can adjust the size, position, or both of the digital image relative to the background digital image.

20. The system of claim 18, where the consumer can view the custom digital image in a special item, where the consumer can adjust the size, position, or both of the custom digital image relative to the special item, and where the consumer can purchase the special item over the internet.
